(19) United States
(12) Patent Application Publication
(10) Pub. No.: US 2024/0111026 A1
(43) Pub. Date: Apr. 4, 2024

(54) LASER RANGEFINDER WITH MAGNETIC SUCTION

(71) Applicant: SNDWAY TECHNOLOGY (GUANGDONG) CO., LTD., Dongguan (CN)

(72) Inventors: Xiaojian XU, Dongguan (CN); Gang HE, Dongguan (CN)

(21) Appl. No.: 18/465,177

(22) Filed: Sep. 12, 2023

(30) Foreign Application Priority Data
Sep. 30, 2022 (CN) 2022226150522

(51) Int. Cl. G01S 7/481; G01S 7/51

(52) U.S. Cl. CPC G01S 7/4813; G01S 7/51

(57) ABSTRACT

A laser rangefinder with magnetic suction includes a first shell, a second shell, a display screen, a control button, a laser ranging device and a magnet device used to fix the laser rangefinder on a metal frame by magnetic suction. A front end of the first shell is provided with the display screen and the control button, a first accommodating cavity is formed between the first shell and the second shell, the laser ranging device is disposed in the first accommodating cavity, and the magnet device is disposed on the second shell. In this case, the laser rangefinder with magnetic suction makes the measurement more convenient and ensures the accuracy of the measurement results.

### TECHNICAL FIELD

The disclosure relates to the technical field of measuring device, and particularly to a laser rangefinder with magnetic suction.

### BACKGROUND

A laser rangefinder is a high-precision measuring instrument, which processes an emitted laser beam and a laser beam reflected back by a targeted object to obtain a distance between the laser rangefinder and the targeted object.

At present, the laser rangefinder is a necessary tool for construction and decoration professionals, which is frequently used, especially on the high-altitude metal frame.

However, since the existing laser rangefinder cannot be fixed on the metal frame, it still needs to be held and fixed by a user, which causes problems such as inconvenient operation and easy falling.

### SUMMARY

In view of the above shortcomings and deficiencies of the related art, the disclosure provides a laser rangefinder with magnetic suction, which solves the technical problems of the existing laser rangefinder, such as inconvenient operation and easy falling due to the need to hold the existing laser rangefinder.

In order to achieve the above purposes, the main technical solutions adopted by the disclosure are as follows.

Specifically, an embodiment of the disclosure provides a laser rangefinder with magnetic suction, the laser rangefinder with magnetic suction includes a first shell, a second shell, a display screen, a control button, a laser ranging device and a magnet device configured (i.e., structured and arranged) to fix the laser rangefinder on a metal frame by magnetic suction. A front end of the first shell is provided with the display screen and the control button. A first accommodating cavity is formed between the first shell and the second shell, the laser ranging device is disposed in the first accommodating cavity, and the magnet device is disposed on the second shell.

In an embodiment, the magnetic device is disposed on an outer surface of the second shell.

In an embodiment, the magnet device is fixed on the outer surface of the second shell by adhesion.

In an embodiment, the magnet device and the second shell are an integrated forming structure.

In an embodiment, a rear side of the display screen is connected to the laser ranging device, and the outer surface of the second shell is provided with a battery installation groove recessed along an internal direction of the second shell. A second accommodating cavity is formed among the battery installation groove, the laser ranging device and the second shell, and the magnet device is disposed in the second accommodating cavity.

In an embodiment, the magnet device is fixed on an inner surface of the second shell by adhesion.

In an embodiment, the magnet device is fixed on the inner surface of the second shell by screw connection.

In an embodiment, a gap is arranged between the laser ranging device disposed in a rear side surface of the second accommodating cavity and a front end surface of the magnet device.

In an embodiment, the front end of the first shell is provided with a leveling device.

In an embodiment, the leveling device includes a first level instrument and a second level instrument; the control button and the second level instrument are disposed at a first side of the display screen, the first level instrument is disposed at a second side of the display screen, and a direction of the first side is perpendicular to a direction of the second side.

The benefits of the disclosure are as follows.

The laser rangefinder with magnetic suction is provided with the magnet device, so that the laser rangefinder can be attached to the metal frame through the magnet device, which makes the measurement more convenient. The laser rangefinder with magnetic suction avoids the problems of inaccurate measurement caused by shaking hands in the handheld process, which can also ensure the accuracy of the measurement results

In order to make the above objectives, features, and advantages to be achieved by the embodiments of the disclosure more clearly and understandable, the following embodiments are illustrated in detail with reference to the attached drawings as follows.

### BRIEF DESCRIPTION OF DRAWINGS

In order to describe technical solutions of embodiments of the disclosure more clearly, a brief introduction will be given to the attached drawings required in the embodiments of the disclosure. It should be understood that the following drawings only illustrate some embodiments of the disclosure, and therefore it should not be regarded as limiting the scope. For those skilled in the art, other relevant drawings can also be obtained based on the attached drawings without creative labor.

FIG. 1 illustrates a front view diagram of a laser rangefinder with magnetic suction according to an embodiment of the disclosure.

FIG. 2 illustrates a side view schematic diagram of a cross section of the laser rangefinder with magnetic suction according to the embodiment of the disclosure.

FIG. 3 illustrates an exploded view of the laser rangefinder with magnetic suction according to the embodiment of the disclosure.

Description of reference signs: 1. second shell; 2. double-sided adhesive; 3. magnet device; 4. laser ranging device; 5. first shell; 6. display lens; 7. control button; 8. battery; 9. battery cover; 10. metal frame; 11. display screen; 121. first level instrument; 122. second level instrument;

### DETAILED DESCRIPTION OF EMBODIMENTS

In order to better describe the disclosure and facilitate understanding of the disclosure, the following is a detailed description of the disclosure through specific embodiments combined with the attached drawings.

To solve the problems of inconvenient operation and easy falling of the existing handheld laser device, the laser rangefinder proposed in an embodiment of the disclosure is added a magnet device inside or on an external surface of the traditional handheld laser rangefinder, so that the laser rangefinder can be attached to a metal frame through the magnet device, thus making the measurement more convenient. The laser rangefinder avoids the problem of inaccurate measurement caused by hand shaking during the existing handheld process, which can ensure the accuracy of measurement results.

In order to better understand the above technical solutions, illustrated embodiments of the disclosure will be described below in more detail with reference to the attached drawings. Although the illustrated embodiments of the disclosure are shown in the attached drawings, it should be understood that the disclosure can be implemented in various forms and should not be limited by the embodiments described herein. On the contrary, the embodiments are provided in order to understand the disclosure more clearly and thoroughly, and to fully convey the scope of the disclosure to those skilled in the art.

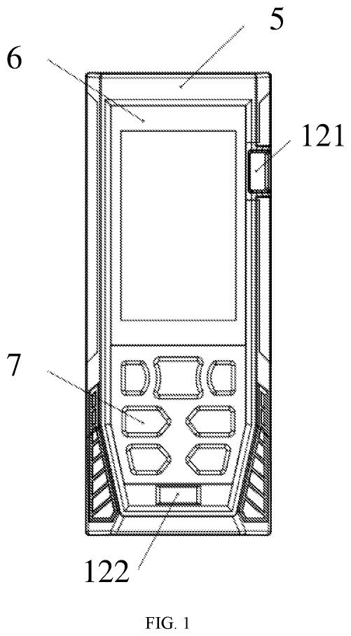

As shown in FIGS. 1-3, a laser rangefinder with magnetic suction includes a first shell 5, a second shell 1, a display screen 11, a control button 7, a laser ranging device 4 and a magnet device 3 configured to fix the laser rangefinder on a metal frame 10 by magnetic suction. The laser ranging device 4 is configured to emit a laser to a measured object surface to measure a numerical value, the display screen 11 is configured to display the numerical value measured by the laser ranging device 4, and the control button 7 is configured to control on-off and measurement of the laser ranging device 4.

It should be understood that the first shell 5 can also be referred to as an upper shell, and the second shell 1 can also be referred to as a bottom shell.

In an embodiment, the display screen 11 and the control button 7 are disposed at a front end of the first shell 5, and the control button 7 is disposed on a first side of the display screen 11 (e.g., as shown in FIG. 1, the control button 7 is disposed above the display screen 11). The first shell 5 and the second shell 1 is detachably connected, so that a first accommodating cavity can be formed between the first shell 5 and the second shell 1, and the laser ranging device 4 and the magnet device 3 are both disposed in the first accommodating cavity.

It should be understood that a specific layout of the laser ranging device 4 and the magnet device 3 in the first accommodating cavity can be disposed according to actual needs, and the embodiments of the disclosure are not limited to the situation.

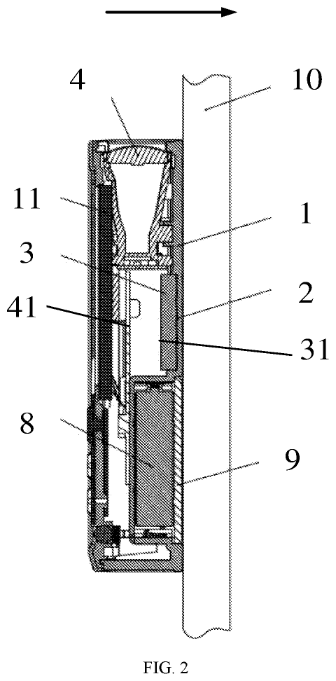

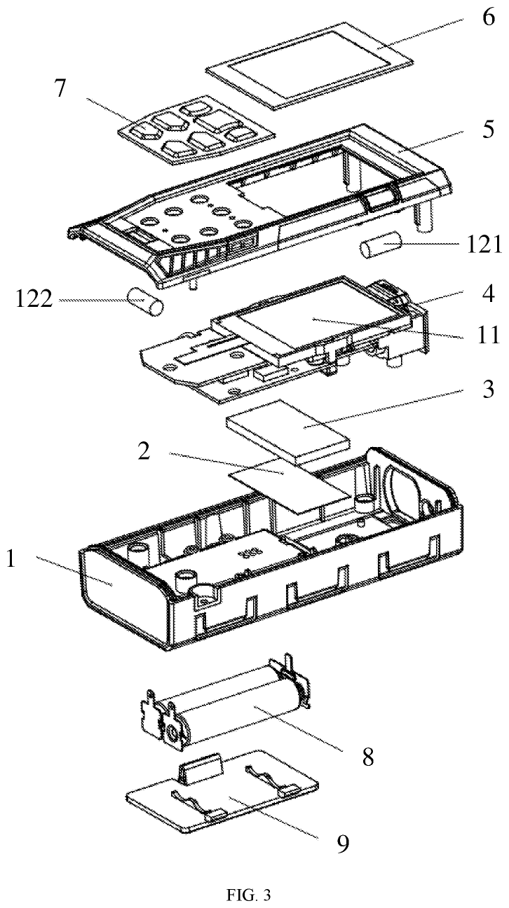

In an embodiment, as shown in FIGS. 2-3, a rear side of the display screen 11 (e.g., an arrow direction in FIG. 2 represents a direction from a front side to the rear side) and the laser ranging device are fixedly connected. An outer surface of the second shell 1 is provided with a battery installation groove recessed along an internal direction of the second shell 1, a second accommodating cavity is formed among the battery installation groove, the laser ranging device 4, and the second shell 1 (i.e., a bottom wall of the second shell 1 and a side wall of the laser ranging device 4, and a side wall of the battery installation groove are enclosed to form the second accommodating cavity), and the magnet device 3 is disposed in the second accommodating cavity. The laser rangefinder further includes a battery 8 used to supply power to the laser ranging device 4 and the display screen 11 and a battery cover 9 adapted to the battery installation groove.

It should be understood that the specific number, size and setting form of the magnet device 3 can be set according to the actual needs, as long as it is ensured that the laser rangefinder can be fixed on the metal frame (e.g., an iron frame) by magnetic suction, and the embodiment of the disclosure is not limited to the situation.

In an embodiment, the magnet device 3 is fixed on an inner surface of the second shell by adhesion.

For example, as shown in FIG. 1, the magnet device 3 can be fixed on the bottom wall of the second shell 1 through a double-sided adhesive 2.

In an embodiment, the magnet device is fixed on an inner surface of the second shell by screw connection.

For example, the magnet device 3 can be fixed to the bottom wall of the second shell 1 by screws.

In an embodiment, as shown in FIG. 2, a gap is arranged between the laser ranging device 4 disposed in a rear side surface 41 of the second accommodating cavity and a front end surface of the magnet device 3, thereby avoiding the problem of the magnet device 3 not being firmly fixed due to the squeezing of the magnet device 3 caused by the laser ranging device 4.

In an embodiment, as shown in FIG. 1, the front end of the first shell 5 is provided with a horizontal device used to determine whether the laser rangefinder is in a horizontal state. The horizontal device can include a first level instrument 121. The control button 7 disposed at the first side of the display screen 11, and the first level instrument 121 disposed at a second side of the display screen 11, and a direction of the first side the display screen 11 is perpendicular to a direction of the second side the display screen 11. The horizontal device can further include a second level instrument 122, which is disposed at a side of the control button, and the first level instrument 121 and the second level instrument 122 can be fixed inside the first shell 5.

In an embodiment, as shown in FIGS. 1 and 3, the laser rangefinder can further include a display lens 6, which can be fixed outside the first shell 5.

It should be understood that the specific setting and relevant parameters of each device in the laser rangefinder can be set according to the actual needs, and the embodiment of the disclosure is not limited to the situation.

In a specific embodiment, the first shell 5 and the second shell 1 can both be made of polytetrafluoroethylene, which has advantages of falling resistance, high temperature resistance and corrosion resistance, so that the shells can effectively protect the internal parts of the laser rangefinder.

In a specific embodiment, the magnet device 3 can be a common magnet, which can achieve function of magnetic suction without the need for electrification or other ways.

In a specific embodiment, the display 11 can be a liquid crystal display (LCD) screen.

It should also be understood that although the laser rangefinder with magnetic suction is described above through FIGS. 1 to 3, those skilled in the art should understand that the laser rangefinder with magnetic suction can also be adjusted, and the embodiment of the disclosure is not limited to the situation.

In an embodiment, the magnet device 3 can also be disposed on the outer surface of the second shell 1.

In a specific embodiment, the magnetic device 3 can be disposed on an outer surface of the battery cover 9 of the second shell 1, and the magnet device 3 can be disposed on a side of the battery installation groove.

It should be understood that a size and a fixing method of the magnet device 3 can be set according to actual needs, and the embodiments of the disclosure are not limited to the situation.

In a specific embodiment, the magnet device 3 is fixed on the outer surface of the second shell 1 by adhesion.

In a specific embodiment, the magnet device 3 and the second shell 1 are integrally formed, the second shell 1 and the magnet device 3 can be placed together in a mold to form an integrated forming structure.

Therefore, the laser rangefinder proposed in the embodiment of the disclosure is added the magnet device inside or on the external surface of the traditional handheld laser rangefinder, so that the laser rangefinder can be attached to the metal frame through the magnet device, thus making the measurement more convenient. Moreover, it can also ensure the accuracy of the measurement results because it avoids the problem of inaccurate measurement caused by shaking hands in the existing handheld process.

It should be understood that the laser rangefinder is only illustrative, and those skilled in the art can make various deformations according to the above methods, and the contents after modification or deformation are also within the protection scope of the disclosure.

In the description of this disclosure, it should be understood that the terms “first” and “second” are only used for descriptive purposes and cannot be understood as indicating or implying relative importance or implying the number of indicated technical features. Therefore, features limited to “first” and “second” can explicitly or implicitly include one or more of these features. In the description of this disclosure, the meaning of “multiple” refers to two or more, unless otherwise specified.

In the disclosure, unless otherwise specified and limited, the terms “installation”, “connected”, “connection”, “fixed” and other terms should be broadly understood, for example, they can be fixed connection, detachable connection, or integrated. It can be a mechanical connection or an electrical connection. It can be directly connected or indirectly connected through an intermediate medium. It can be the internal connection between two components or the interaction relationship between two components. For those skilled in the art, the specific meanings of the above terms in this disclosure can be understood based on specific circumstances.

In the disclosure, unless otherwise specified and limited, a first feature disposed “above” or “below” a second feature can be understood that the first feature is in direct contact with the second feature or the first feature is in indirect contact with the second feature through an intermediate medium. Moreover, the first feature disposed “on”, “up”, and “above” the second feature can be that the first feature is directly or obliquely above the second feature, or simply indicating a horizontal height of the first feature is higher than that of the second feature. The first feature deposed “under”, “down”, and “below” the second feature can be directly or obliquely below the first feature, or simply indicating that the horizontal height of the first feature is lower than that of the second feature.

In the description of the specification, the terms “an embodiment”, “some embodiments”, “embodiments”, “examples”, “specific examples”, or “some examples” mean that the specific features, structures, materials, or characteristic described in conjunction with the embodiment or example are included in at least one embodiment or example of the disclosure. In this specification, the schematic expressions of the above terms do not necessarily refer to the same embodiments or examples. Moreover, the specific features, structures, materials, or characteristic described can be combined in an appropriate manner in any one or more embodiments or examples. In addition, the different embodiments or examples and the features of the different embodiments or examples described in this specification may be combined and incorporated by those skilled in the art without mutual contradiction.

Although the embodiments of the disclosure have been shown and described above, it can be understood that the above embodiments are illustrative and cannot be understood as limitations to the disclosure. Those skilled in the art can make changes, modifications, substitutions, and variations to the above embodiments within the scope of the disclosure.

What is claimed is:

1. A laser rangefinder with magnetic suction, comprising:
a first shell, a second shell, a display screen, a control button, a laser ranging device and a magnet device configured to fix the laser rangefinder on a metal frame by the magnetic suction;
wherein a front end of the first shell is provided with the display screen and the control button, a first accommodating cavity is formed between the first shell and the second shell, the laser ranging device is disposed in the first accommodating cavity, and the magnet device is disposed on the second shell.

2. The laser rangefinder with magnetic suction as claimed in claim 1, wherein the magnet device is disposed on an outer surface of the second shell.

3. The laser rangefinder with magnetic suction as claimed in claim 2, wherein the magnet device is fixed on the outer surface of the second shell by adhesion.

4. The laser rangefinder with magnetic suction as claimed in claim 2, wherein the magnet device and the second shell are an integrated forming structure.

5. The laser rangefinder with magnetic suction as claimed in claim 1, wherein a rear side of the display screen is connected to the laser ranging device, an outer surface of the second shell is provided with a battery installation groove recessed along an internal direction of the second shell; a second accommodating cavity is formed among the battery installation groove, the laser ranging device and the second shell, and the magnet device is disposed in the second accommodating cavity.

6. The laser rangefinder with magnetic suction as claimed in claim 5, wherein the magnet device is fixed on an inner surface of the second shell by adhesion.

7. The laser rangefinder with magnetic suction as claimed in claim 5, wherein the magnet device is fixed on an inner surface of the second shell by screw connection.

8. The laser rangefinder with magnetic suction as claimed in claim 5, wherein a gap is arranged between the laser ranging device disposed in a rear side surface of the second accommodating cavity and a front end surface of the magnet device.

9. The laser rangefinder with magnetic suction as claimed in claim 1, wherein the front end of the first shell is provided with a leveling device.

10. The laser rangefinder with magnetic suction as claimed in claim 9, wherein the leveling device comprises a first level instrument and a second level instrument, the control button and the second level instrument are disposed at a first side of the display screen, the first level instrument is disposed at a second side of the display screen, and a direction of the first side is perpendicular to a direction of the second side.

11. A laser rangefinder, comprising:
a first shell;
a second shell, disposed below the first shell and detachably connected to the first shell to form a first accommodating cavity;
a display screen, disposed at a front end of the first shell;
a control button, disposed at the front end of the first shell and arranged with the display screen side by side;
a laser ranging device, disposed in the first accommodating cavity; and
a magnet device, disposed on the second shell and configured to fix the laser rangefinder on a metal frame by magnetic suction;
wherein the laser ranging device is configured to emit a laser to a measured object surface to measure a numerical value, the display screen is configured to display the numerical value measured by the laser ranging device, and the control button is configured to control on-off states and measurement of the laser ranging device.

12. The laser rangefinder as claimed claim 11, wherein the magnet device is disposed on an outer surface of the second shell.

13. The laser rangefinder as claimed claim 12, wherein the magnet device is fixed on the outer surface of the second shell by a double-sided adhesive.

14. The laser rangefinder as claimed claim 11, wherein the laser ranging device is fixedly connected to a rear side of the display screen.

15. The laser rangefinder as claimed claim 14, wherein an outer surface of the second shell is provided with a battery installation groove recessed along an internal direction of the second shell; and the laser rangefinder further comprises:
a battery, disposed in the battery installation groove and configured to supply power to the laser ranging device and the display screen; and
a battery cover, adapted to the battery installation groove.

16. The laser rangefinder as claimed claim 11, further comprising:
a leveling device, configured to determine whether the laser rangefinder is in a horizontal state;
wherein the leveling device comprises a first level instrument and a second level instrument, and the first level instrument and the second level instrument are fixed inside the first shell.

17. A laser rangefinder, comprising:
a first shell;
a second shell, wherein the second shell is disposed below the first shell and provided with a battery installation groove, and detachably connected to the first shell to form a first accommodating cavity;
a display screen, disposed at a front end of the first shell;
a control button, disposed at the front end of the first shell and arranged with the display screen side by side;
a laser ranging device, disposed in the first accommodating cavity;
a magnet device, disposed on the second shell and configured to fix the laser rangefinder on a metal frame by magnetic suction; and
a battery, disposed in the battery installation groove and configured to supply power to the laser ranging device and the display screen.

18. The laser rangefinder as claimed 17, wherein the magnet device is fixed to the second shell through one of adhesion and screw connection.

19. The laser rangefinder as claimed 18, wherein the laser ranging device is fixedly connected to a rear side of the display screen, and the battery installation groove is recessed along an internal direction of the second shell.

20. The laser rangefinder as claimed 19, further comprising:
a leveling device, configured to determine whether the laser rangefinder is in a horizontal state;
wherein the leveling device comprises a first level instrument and a second level instrument, and the first level instrument and the second level instrument are fixed inside the first shell.
